(19) United States
(12) Patent Application Publication
(10) Pub. No.: US 2009/0228940 A1
(43) Pub. Date: Sep. 10, 2009

(54) METHOD AND APPARATUS FOR MANAGING TELEPHONE COMMUNICATIONS

(75) Inventor: Geoffrey R. Zampiello, Norwalk, CT (US)

Correspondence Address: AT&T Legal Department - AS;Attn: Patent Docketing, Room 2A-207, One AT&T Way, Bedminster, NJ, 07921, US

(73) Assignee: AT&T KNOWLEDGE VENTURES LP, RENO, NV (US)

(21) Appl. No.: 12/044,257

(22) Filed: Mar. 7, 2008

(51) Int. Cl. H04N 7/173; H04M 1/56

(52) U.S. Cl. 725/106; 379/142.16; 725/131

(57) ABSTRACT

A system that incorporates teachings of the present disclosure may include, for example, a set top box having a controller to receive a call from a communication device, present notice of receipt of the call on a display device coupled to the set top box, provide a message to the communication device that a user of the set top box will provide a return call at a pre-determined time, and initiate the return call from the set top box at the pre-determined time. Other embodiments are disclosed.

### FIELD OF THE DISCLOSURE

The present disclosure relates generally to communication systems and more specifically to a method and apparatus for managing telephone communications.

### BACKGROUND

Television viewing is part of daily life. Some individuals prefer not to be disturbed while watching television, while other individuals will pause the media content or will miss a portion of the content to accomplish a task. When notice of an incoming call is received, some of these individuals prefer to allow the call to go unanswered or into voice mail, while other individuals prefer to answer the call.

Meeting the needs of these preferences can be difficult. The difficulty can be exacerbated where the preferences change, such as based on the identity of the caller. Systems that forward unanswered calls to voice mail can accumulate a number of messages to be reviewed which can be a time-consuming process. These systems can also fail to discriminate amongst more important incoming calls.

### DESCRIPTION OF THE DRAWINGS

FIGS. 1-4 depict exemplary embodiments of communication systems that provide media services;

FIG. 5 depicts an exemplary embodiment of a portal interacting with at least one among the communication systems of FIGS. 1-4;

FIG. 6 depicts an exemplary method operating in portions of the communication systems of FIGS. 1-4; and

FIG. 7 is a diagrammatic representation of a machine in the form of a computer system within which a set of instructions, when executed, may cause the machine to perform any one or more of the methodologies discussed herein.

### DETAILED DESCRIPTION

One embodiment of the present disclosure entails a computer-readable storage medium, having computer instructions for receiving a call at a set top box from a communication device, presenting notice of receipt of the call on a display device coupled to the set top box, providing a message to the communication device that a user of the set top box will provide a return call at a specified time, and initiating the return call from the set top box to the communication device at the specified time.

Another embodiment of the present disclosure entails a set top box having a controller to receive a call from a communication device where the set top box is in communication with an internet protocol television system for presenting media content on a display device, present notice of receipt of the call on the display device, retrieve a call management function from a profile associated with a user of the set top box, apply the call management function to the call, and initiate a return call from the set top box at a pre-determined time.

Yet another embodiment of the present disclosure entails a set top box having a controller to receive a call from a communication device, present notice of receipt of the call on a display device coupled to the set top box, provide a message to the communication device that a user of the set top box will provide a return call at a pre-determined time, and initiate the return call from the set top box at the pre-determined time.

Yet another embodiment of the present disclosure entails a set top box having a controller to receive a call from a communication device where the set top box is in communication with an internet protocol television system, present notice of receipt of the call on a display device coupled to the set top box, present a list of call management functions on the display device where the call management functions include initiating a return call at a predetermined time, receive a selection of a call management function from a user of the set top box, and apply the selected call management function to the call.

Yet another embodiment of the present disclosure entails a method including receiving a call at a set top box from a communication device where the set top box is in communication with an internet protocol television system, presenting notice of receipt of the call on a display device coupled to the set top box, retrieving a call management function from a web page associated with the set top box where the call management function is adjustable by a plurality of devices in communication with the web page over the internet and where the plurality of devices include a remote controller of the set top box and a mobile phone, and applying the call management function to the call.

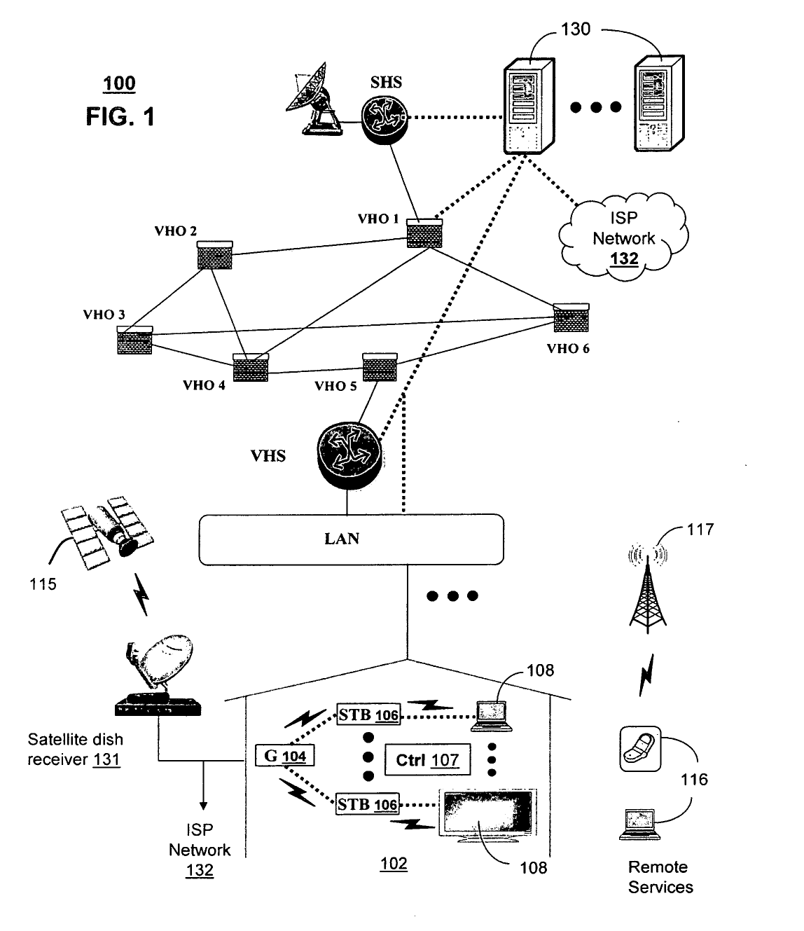

FIG. 1 depicts an exemplary embodiment of a first communication system 100 for delivering media content. The communication system 100 can represent an Internet Protocol Television (IPTV) broadcast media system. In a typical IPTV infrastructure, there is at least one super head-end office server (SHS) which receives national media programs from satellite and/or media servers from service providers of multimedia broadcast channels. In the present context, media programs can represent audio content, moving image content such as videos, still image content, and/or combinations thereof. The SHS server can forward IP packets associated with the media content to video head-end servers (VHS) via a network of aggregation points such as video head-end offices (VHO) according to a common multicast communication method.

The VHS can then distribute multimedia broadcast programs via a local area network (LAN) to commercial and/or residential buildings 102 housing a gateway 104 (e.g., a residential gateway or RG). The LAN can represent a bank of digital subscriber line access multiplexers (DSLAMs) located in a central office or a service area interface that provide broadband services over optical links or copper twisted pairs to buildings 102. The gateway 104 can distribute broadcast signals to media processors 106, such as Set-Top Boxes (STBs), which in turn present broadcast selections to media devices 108, such as computers or television devices, managed in some instances by a media controller 107 (e.g., an infrared or RF remote control). Unicast traffic can also be exchanged between the media processors 106 and subsystems of the IPTV media system for services such as video-on-demand (VoD). It will be appreciated by one of ordinary skill in the art that the media devices 108 and/or portable communication devices 116 shown in FIG. 1 can be an integral part of the media processor 106 and can be communicatively coupled to the gateway 104. In this particular embodiment, an integral device such as described can receive, respond, process and/or present multicast or unicast media content.

The IPTV media system can be coupled to one or more computing devices 130 a portion of which can operate as a web server for providing portal services over an Internet Service Provider (ISP) network 132 to fixed line media devices 108 or portable communication devices 116 by way of a wireless access point 117 providing Wireless Fidelity or WiFi services, or cellular communication services (e.g., GSM, CDMA, UMTS, WiMAX, etc.).

A satellite broadcast television system can be used in place of, or in combination with, the IPTV media system. In this embodiment, signals transmitted by a satellite 115 can be intercepted by a satellite dish receiver 131 coupled to building 102 which conveys media signals to the media processors 106. The media receivers 106 can be equipped with a broadband port to the ISP network 132. Although not shown, the communication system 100 can also be combined or replaced with analog or digital broadcast distributions systems, such as cable TV systems.

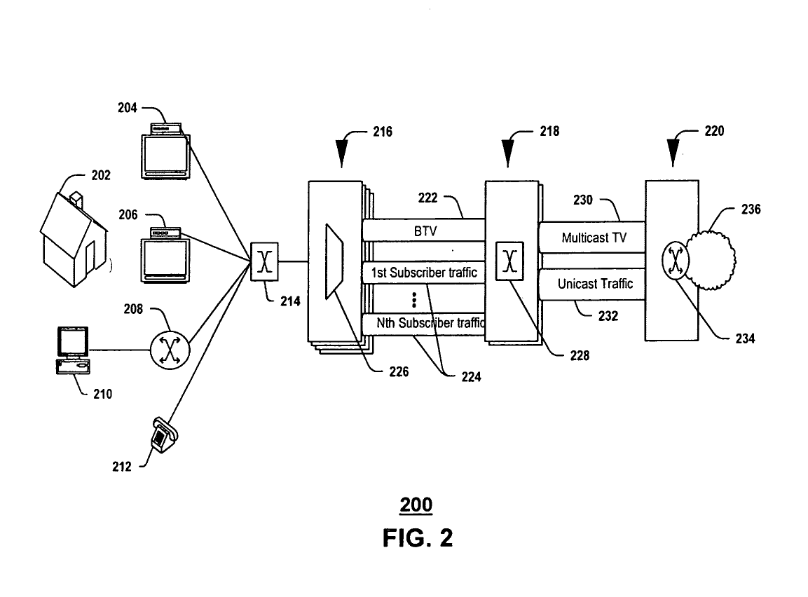

FIG. 2 depicts an exemplary embodiment of a second communication system 200 for delivering media content. Communication system 200 can be overlaid or operably coupled with communication system 100 as another representative embodiment of said communication system. The system 200 can include a distribution switch/router system 228 at a central office 218. The distribution switch/router system 228 can receive video data via a multicast television stream 230 from a second distribution switch/router 234 at an intermediate office 220. The multicast television stream 230 can include Internet Protocol (IP) data packets addressed to a multicast IP address associated with a television channel. The distribution switch/router system 228 can cache data associated with each television channel received from the intermediate office 220.

The distribution switch/router system 228 can also receive unicast data traffic from the intermediate office 220 via a unicast traffic stream 232. The unicast traffic stream 232 can include data packets related to devices located at a particular residence, such as the residence 202. For example, the unicast traffic stream 232 can include data traffic related to a digital subscriber line, a telephone line, another data connection, or any combination thereof. To illustrate, the unicast traffic stream 232 can communicate data packets to and from a telephone 212 associated with a subscriber at the residence 202. The telephone 212 can be a Voice over Internet Protocol (VoIP) telephone. To further illustrate, the unicast traffic stream 232 can communicate data packets to and from a personal computer 210 at the residence 202 via one or more data routers 208. In an additional illustration, the unicast traffic stream 232 can communicate data packets to and from a set-top box device, such as the set-top box devices 204, 206. The unicast traffic stream 232 can communicate data packets to and from the devices located at the residence 202 via one or more residential gateways 214 associated with the residence 202.

The distribution switch/router system 228 can send data to one or more access switch/router systems 226. The access switch/router system 226 can include or be included within a service area interface 216. In a particular embodiment, the access switch/router system 226 can include a DSLAM. The access switch/router system 226 can receive data from the distribution switch/router system 228 via a broadcast television (BTV) stream 222 and a plurality of unicast subscriber traffic streams 224. The BTV stream 222 can be used to communicate video data packets associated with a multicast stream.

For example, the BTV stream 222 can include a multicast virtual local area network (VLAN) connection between the distribution switch/router system 228 and the access switch/router system 226. Each of the plurality of subscriber traffic streams 224 can be used to communicate subscriber specific data packets. For example, the first subscriber traffic stream can communicate data related to a first subscriber, and the nth subscriber traffic stream can communicate data related to an nth subscriber. Each subscriber to the system 200 can be associated with a respective subscriber traffic stream 224. The subscriber traffic stream 224 can include a subscriber VLAN connection between the distribution switch/router system 228 and the access switch/router system 226 that is associated with a particular set-top box device 204, 206, a particular residence 202, a particular residential gateway 214, another device associated with a subscriber, or any combination thereof.

In an illustrative embodiment, a set-top box device, such as the set-top box device 204, can receive a channel change command from an input device, such as a remoter control device. The channel change command can indicate selection of an IPTV channel. After receiving the channel change command, the set-top box device 204 can generate channel selection data that indicates the selection of the IPTV channel. The set-top box device 204 can send the channel selection data to the access switch/router system 226 via the residential gateway 214. The channel selection data can include an Internet Group Management Protocol (IGMP) Join request. In an illustrative embodiment, the access switch/router system 226 can identify whether it is joined to a multicast group associated with the requested channel based on information in the IGMP Join request.

If the access switch/router system 226 is not joined to the multicast group associated with the requested channel, the access switch/router system 226 can generate a multicast stream request. The multicast stream request can be generated by modifying the received channel selection data. In an illustrative embodiment, the access switch/router system 226 can modify an IGMP Join request to produce a proxy IGMP Join request. The access switch/router system 226 can send the multicast stream request to the distribution switch/router system 228 via the BTV stream 222. In response to receiving the multicast stream request, the distribution switch/router system 228 can send a stream associated with the requested channel to the access switch/router system 226 via the BTV stream 222.

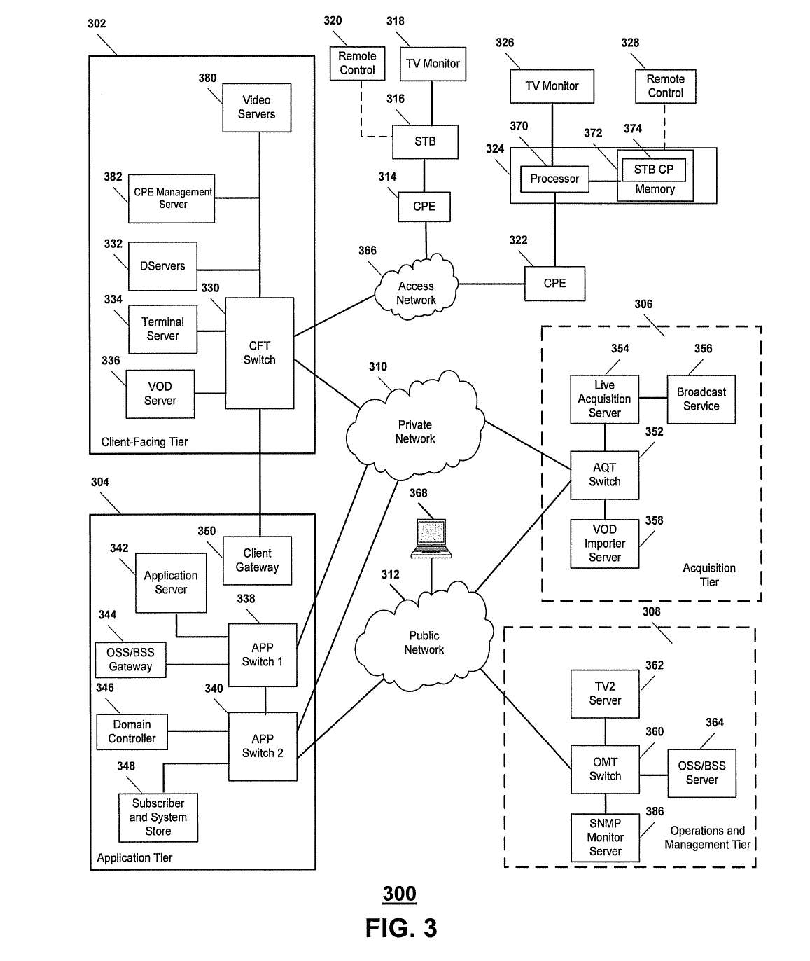

FIG. 3 depicts an exemplary embodiment of a third communication system 300 for delivering media content. Communication system 300 can be overlaid or operably coupled with communication systems 100-200 as another representative embodiment of said communication systems. As shown, the system 300 can include a client facing tier 302, an application tier 304, an acquisition tier 306, and an operations and management tier 308. Each tier 302, 304, 306, 308 can be coupled to a private network 310, such as a network of common packet-switched routers and/or switches; to a public network 312, such as the Internet; or to both the private network 310 and the public network 312. For example, the client-facing tier 302 can be coupled to the private network 310. Further, the application tier 304 can be coupled to the private network 310 and to the public network 312. The acquisition tier 306 can also be coupled to the private network 310 and to the public network 312. Additionally, the operations and management tier 308 can be coupled to the public network 322.

As illustrated in FIG. 3, the various tiers 302, 304, 306, 308 can communicate with each other via the private network 310 and the public network 312. For instance, the client-facing tier 302 can communicate with the application tier 304 and the acquisition tier 306 via the private network 310. The application tier 304 can communicate with the acquisition tier 306 via the private network 310. Further, the application tier 304 can communicate with the acquisition tier 306 and the operations and management tier 308 via the public network 312. Moreover, the acquisition tier 306 can communicate with the operations and management tier 308 via the public network 312. In a particular embodiment, elements of the application tier 304, including, but not limited to, a client gateway 350, can communicate directly with the client-facing tier 302.

The client-facing tier 302 can communicate with user equipment via an access network 366, such as an IPTV access network. In an illustrative embodiment, customer premises equipment (CPE) 314, 322 can be coupled to a local switch, router, or other device of the access network 366. The client-facing tier 302 can communicate with a first representative set-top box device 316 via the first CPE 314 and with a second representative set-top box device 324 via the second CPE 322. In a particular embodiment, the first representative set-top box device 316 and the first CPE 314 can be located at a first customer premise, and the second representative set-top box device 324 and the second CPE 322 can be located at a second customer premise.

In another particular embodiment, the first representative set-top box device 316 and the second representative set-top box device 324 can be located at a single customer premise, both coupled to one of the CPE 314, 322. The CPE 314, 322 can include routers, local area network devices, modems, such as digital subscriber line (DSL) modems, any other suitable devices for facilitating communication between a set-top box device and the access network 366, or any combination thereof.

In an exemplary embodiment, the client-facing tier 302 can be coupled to the CPE 314, 322 via fiber optic cables. In another exemplary embodiment, the CPE 314, 322 can include DSL modems that are coupled to one or more network nodes via twisted pairs, and the client-facing tier 302 can be coupled to the network nodes via fiber-optic cables. Each set-top box device 316, 324 can process data received via the access network 366, via a common IPTV software platform.

The first set-top box device 316 can be coupled to a first external display device, such as a first television monitor 318, and the second set-top box device 324 can be coupled to a second external display device, such as a second television monitor 326. Moreover, the first set-top box device 316 can communicate with a first remote control 320, and the second set-top box device 324 can communicate with a second remote control 328. The set-top box devices 316, 324 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof.

In an exemplary, non-limiting embodiment, each set-top box device 316, 324 can receive data, video, or any combination thereof, from the client-facing tier 302 via the access network 366 and render or display the data, video, or any combination thereof, at the display device 318, 326 to which it is coupled. In an illustrative embodiment, the set-top box devices 316, 324 can include tuners that receive and decode television programming signals or packet streams for transmission to the display devices 318, 326. Further, the set-top box devices 316, 324 can each include a STB processor 370 and a STB memory device 372 that is accessible to the STB processor 370. In one embodiment, a computer program, such as the STB computer program 374, can be embedded within the STB memory device 372.

In an illustrative embodiment, the client-facing tier 302 can include a client-facing tier (CFT) switch 330 that manages communication between the client-facing tier 302 and the access network 366 and between the client-facing tier 302 and the private network 310. As illustrated, the CFT switch 330 is coupled to one or more distribution servers, such as Distribution-servers (D-servers) 332, that store, format, encode, replicate, or otherwise manipulate or prepare video content for communication from the client-facing tier 302 to the set-top box devices 316, 324. The CFT switch 330 can also be coupled to a terminal server 334 that provides terminal devices with a point of connection to the IPTV system 300 via the client-facing tier 302.

In a particular embodiment, the CFT switch 330 can be coupled to a video-on-demand (VOD) server 336 that stores or provides VOD content imported by the IPTV system 300. Further, the CFT switch 330 is coupled to one or more video servers 380 that receive video content and transmit the content to the set-top boxes 316, 324 via the access network 366. The client-facing tier 302 may include a CPE management server 382 that manages communications to and from the CPE 314 and the CPE 322. For example, the CPE management server 382 may collect performance data associated with the set-top box devices 316, 324 from the CPE 314 or the CPE 322 and forward the collected performance data to a server associated with the operations and management tier 308.

In an illustrative embodiment, the client-facing tier 302 can communicate with a large number of set-top boxes, such as the representative set-top boxes 316, 324, over a wide geographic area, such as a metropolitan area, a viewing area, a statewide area, a regional area, a nationwide area or any other suitable geographic area, market area, or subscriber or customer group that can be supported by networking the client-facing tier 302 to numerous set-top box devices. In a particular embodiment, the CFT switch 330, or any portion thereof, can include a multicast router or switch that communicates with multiple set-top box devices via a multicast-enabled network.

As illustrated in FIG. 3, the application tier 304 can communicate with both the private network 310 and the public network 312. The application tier 304 can include a first application tier (APP) switch 338 and a second APP switch 340. In a particular embodiment, the first APP switch 338 can be coupled to the second APP switch 340. The first APP switch 338 can be coupled to an application server 342 and to an OSS/BSS gateway 344. In a particular embodiment, the application server 342 can provide applications to the set-top box devices 316, 324 via the access network 366, which enable the set-top box devices 316, 324 to provide functions, such as interactive program guides, video gaming, display, messaging, processing of VOD material and other IPTV content, etc. In an illustrative embodiment, the application server 342 can provide location information to the set-top box devices 316, 324. In a particular embodiment, the OSS/BSS gateway 344 includes operation systems and support (OSS) data, as well as billing systems and support (BSS) data. In one embodiment, the OSS/BSS gateway 344 can provide or restrict access to an OSS/BSS server 364 that stores operations and billing systems data.

The second APP switch 340 can be coupled to a domain controller 346 that provides Internet access, for example, to users at their computers 368 via the public network 312. For example, the domain controller 346 can provide remote Internet access to IPTV account information, e-mail, personalized Internet services, or other online services via the public network 312. In addition, the second APP switch 340 can be coupled to a subscriber and system store 348 that includes account information, such as account information that is associated with users who access the IPTV system 300 via the private network 310 or the public network 312. In an illustrative embodiment, the subscriber and system store 348 can store subscriber or customer data and create subscriber or customer profiles that are associated with IP addresses, stock-keeping unit (SKU) numbers, other identifiers, or any combination thereof, of corresponding set-top box devices 316, 324. In another illustrative embodiment, the subscriber and system store can store data associated with capabilities of set-top box devices associated with particular customers.

In a particular embodiment, the application tier 304 can include a client gateway 350 that communicates data directly to the client-facing tier 302. In this embodiment, the client gateway 350 can be coupled directly to the CFT switch 330. The client gateway 350 can provide user access to the private network 310 and the tiers coupled thereto. In an illustrative embodiment, the set-top box devices 316, 324 can access the IPTV system 300 via the access network 366, using information received from the client gateway 350. User devices can access the client gateway 350 via the access network 366, and the client gateway 350 can allow such devices to access the private network 310 once the devices are authenticated or verified. Similarly, the client gateway 350 can prevent unauthorized devices, such as hacker computers or stolen set-top box devices from accessing the private network 310, by denying access to these devices beyond the access network 366.

For example, when the first representative set-top box device 316 accesses the client-facing tier 302 via the access network 366, the client gateway 350 can verify subscriber information by communicating with the subscriber and system store 348 via the private network 310. Further, the client gateway 350 can verify billing information and status by communicating with the OSS/BSS gateway 344 via the private network 310. In one embodiment, the OSS/BSS gateway 344 can transmit a query via the public network 312 to the OSS/BSS server 364. After the client gateway 350 confirms subscriber and/or billing information, the client gateway 350 can allow the set-top box device 316 to access IPTV content and VOD content at the client-facing tier 302. If the client gateway 350 cannot verify subscriber information for the set-top box device 316, e.g., because it is connected to an unauthorized twisted pair, the client gateway 350 can block transmissions to and from the set-top box device 316 beyond the access network 366.

As indicated in FIG. 3, the acquisition tier 306 includes an acquisition tier (AQT) switch 352 that communicates with the private network 310. The AQT switch 352 can also communicate with the operations and management tier 308 via the public network 312. In a particular embodiment, the AQT switch 352 can be coupled to one or more live Acquisition-servers (A-servers) 354 that receive or acquire television content, movie content, advertisement content, other video content, or any combination thereof, from a broadcast service 356, such as a satellite acquisition system or satellite head-end office. In a particular embodiment, the live acquisition server 354 can transmit content to the AQT switch 352, and the AQT switch 352 can transmit the content to the CFT switch 330 via the private network 310.

In an illustrative embodiment, content can be transmitted to the D-servers 332, where it can be encoded, formatted, stored, replicated, or otherwise manipulated and prepared for communication from the video server(s) 380 to the set-top box devices 316, 324. The CFT switch 330 can receive content from the video server(s) 380 and communicate the content to the CPE 314, 322 via the access network 366. The set-top box devices 316, 324 can receive the content via the CPE 314, 322, and can transmit the content to the television monitors 318, 326. In an illustrative embodiment, video or audio portions of the content can be streamed to the set-top box devices 316, 324.

Further, the AQT switch 352 can be coupled to a video-on-demand importer server 358 that receives and stores television or movie content received at the acquisition tier 306 and communicates the stored content to the VOD server 336 at the client-facing tier 302 via the private network 310. Additionally, at the acquisition tier 306, the VOD importer server 358 can receive content from one or more VOD sources outside the IPTV system 300, such as movie studios and programmers of non-live content. The VOD importer server 358 can transmit the VOD content to the AQT switch 352, and the AQT switch 352, in turn, can communicate the material to the CFT switch 330 via the private network 310. The VOD content can be stored at one or more servers, such as the VOD server 336.

When users issue requests for VOD content via the set-top box devices 316, 324, the requests can be transmitted over the access network 366 to the VOD server 336, via the CFT switch 330. Upon receiving such requests, the VOD server 336 can retrieve the requested VOD content and transmit the content to the set-top box devices 316, 324 across the access network 366, via the CFT switch 330. The set-top box devices 316, 324 can transmit the VOD content to the television monitors 318, 326. In an illustrative embodiment, video or audio portions of VOD content can be streamed to the set-top box devices 316, 324.

FIG. 3 further illustrates that the operations and management tier 308 can include an operations and management tier (OMT) switch 360 that conducts communication between the operations and management tier 308 and the public network 312. In the embodiment illustrated by FIG. 3, the OMT switch 360 is coupled to a TV2 server 362. Additionally, the OMT switch 360 can be coupled to an OSS/BSS server 364 and to a simple network management protocol monitor 386 that monitors network devices within or coupled to the IPTV system 300. In a particular embodiment, the OMT switch 360 can communicate with the AQT switch 352 via the public network 312.

The OSS/BSS server 364 may include a cluster of servers, such as one or more CPE data collection servers that are adapted to request and store operations systems data, such as performance data from the set-top box devices 316, 324. In an illustrative embodiment, the CPE data collection servers may be adapted to analyze performance data to identify a condition of a physical component of a network path associated with a set-top box device, to predict a condition of a physical component of a network path associated with a set-top box device, or any combination thereof.

In an illustrative embodiment, the live acquisition server 354 can transmit content to the AQT switch 352, and the AQT switch 352, in turn, can transmit the content to the OMT switch 360 via the public network 312. In this embodiment, the OMT switch 360 can transmit the content to the TV2 server 362 for display to users accessing the user interface at the TV2 server 362. For example, a user can access the TV2 server 362 using a personal computer 368 coupled to the public network 312.

It should be apparent to one of ordinary skill in the art from the foregoing media communication system embodiments that other suitable media communication systems for distributing broadcast media content as well as peer-to-peer exchange of content can be applied to the present disclosure.

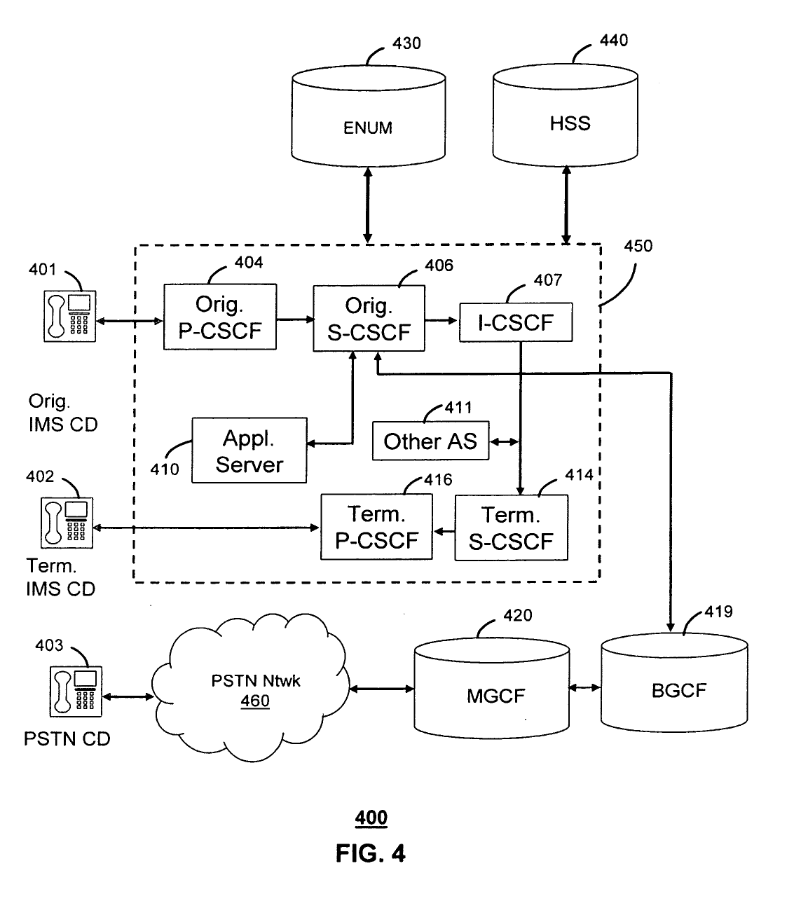

FIG. 4 depicts an exemplary embodiment of a communication system 400 employing a IP Multimedia Subsystem (IMS) network architecture. Communication system 400 can be overlaid or operably coupled with communication systems 100-300 as another representative embodiment of said communication systems.

The communication system 400 can comprise a Home Subscriber Server (HSS) 440, a tElephone NUmber Mapping (ENUM) server 430, and network elements of an IMS network 450. The IMS network 450 can be coupled to IMS compliant communication devices (CD) 401, 402 or a Public Switched Telephone Network (PSTN) CD 403 using a Media Gateway Control Function (MGCF) 420 that connects the call through a common PSTN network 460.

IMS CDs 401, 402 register with the IMS network 450 by contacting a Proxy Call Session Control Function (P-CSCF) which communicates with a corresponding Serving CSCF (S-CSCF) to register the CDs with an Authentication, Authorization and Accounting (AAA) support by the HSS 440. To accomplish a communication session between CDs, an originating IMS CD 401 can submit a SIP INVITE message to an originating P-CSCF 404 which communicates with a corresponding originating S-CSCF 406. The originating S-CSCF 406 can submit the SIP INVITE message to an application server (AS) such as reference 410 that can provide a variety of services to IMS subscribers. For example, the application server 410 can be used to perform originating treatment functions on the calling party number received by the originating S-CSCF 406 in the SIP INVITE message.

Originating treatment functions can include determining whether the calling party number has international calling services, and/or is requesting special telephony features (e.g., *72 forward calls, *73 cancel call forwarding, *67 for caller ID blocking, and so on). Additionally, the originating S-CSCF 406 can submit queries to the ENUM system 430 to translate an E.164 telephone number to a SIP Uniform Resource Identifier (URI) if the targeted communication device is IMS compliant. If the targeted communication device is a PSTN device, the ENUM system 430 will respond with an unsuccessful address resolution and the S-CSCF 406 will forward the call to the MGCF 420 via a Breakout Gateway Control Function (BGCF) 419.

When the ENUM server 430 returns a SIP URI, the SIP URI is used by an Interrogating CSCF (I-CSCF) 407 to submit a query to the HSS 440 to identify a terminating S-CSCF 414 associated with a terminating IMS CD such as reference 402. Once identified, the I-CSCF 407 can submit the SIP INVITE to the terminating S-CSCF 414 which can call on an application server 411 similar to reference 410 to perform the originating treatment telephony functions described earlier. The terminating S-CSCF 414 can then identify a terminating P-CSCF 416 associated with the terminating CD 402. The P-CSCF 416 then signals the CD 402 to establish communications. The aforementioned process can be symmetrical. Accordingly, the terms “originating” and “terminating” in FIG. 4 can be interchanged.

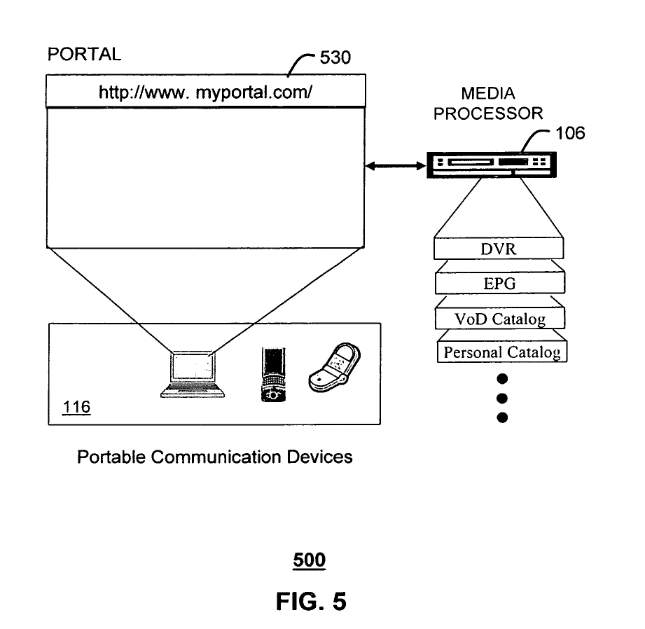

FIG. 5 depicts an exemplary embodiment of a portal 530. The portal 530 can be used for managing services of communication systems 100-400. The portal 530 can be accessed by a Uniform Resource Locator (URL) with a common Internet browser such as Microsoft's Internet Explorer using an Internet-capable communication device such as references 108, 116, or 210 of FIGS. 1-2. The portal 530 can be configured to access a media processor such as references 106, 204, 206, 316, and 324 of FIGS. 1-3 and services managed thereby such as a Digital Video Recorder (DVR), an Electronic Programming Guide (EPG), VOD catalog, a personal catalog stored in the STB (e.g., personal videos, pictures, audio recordings, etc.), and so on.

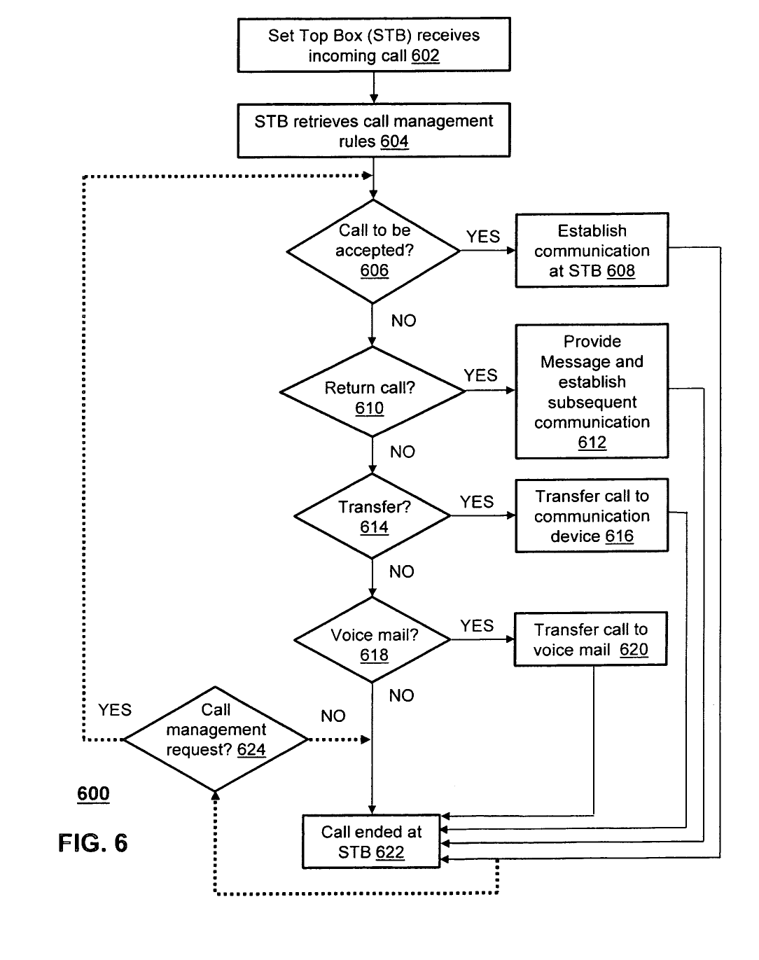

FIG. 6 depicts an exemplary method 600 operating in portions of one or more of the communication systems 100-400. Method 600 has variants as depicted by the dashed lines. It would be apparent to an artisan with ordinary skill in the art that other embodiments not depicted in FIG. 6 are possible without departing from the scope of the claims described below. For convenience, reference to one or more features of communication system 100 as used in the following paragraphs can mean one or more features of the communication systems 100, 200, 300 and 400 singly or in combination, including STBs 106, 204, 206, 316 and/or 324.

Method 600 can begin with step 602 where the STB 106 receives an incoming telephone call. For example, the call can be sent to the STB 106 by the gateway 104 or another server, including a server outside of the residence 102. In one embodiment, the presentation of the call to the STB 106 can be pursuant to a user profile or user pre-designation that is applied by the gateway 104 for choosing calls to be sent to the STB 106 rather than another communication device associated with the residence. In another embodiment, the STB 106 can have its own telephone number, internet address or other communication identification for direct communication with other communication devices. The incoming call can be from various communication devices, including fixed and/or roaming devices, and can be by way of various modes of communication, including VoIP, cellular, Integrated Services Digital Network (ISDN), Plain Old Telephone Service (POTS), and so forth.

In step 604, the STB 106 can retrieve or otherwise determine call management rules or functions associated with calls. In one embodiment, the retrieval of the call management rules can be based on a user profile associated with the STB 106. For example, a user at the start of a media viewing session can be required to enter his or her user profile. The STB 106 can then retrieve stored call management rules associated with the user profile. The particular call management function applied to the incoming call based on the user profile can vary, such as forwarding all calls to voicemail or accepting all calls. In one embodiment, the retrieval of the call management rules can be based on a type of media being presented. For example, the user profile or another designation by a user can indicate that all calls received during viewing of a movie are to be sent to voicemail while all calls received during viewing of the news can be accepted.

In one embodiment, the retrieval of the call management rules can be performed pursuant to a presentation and selection of management options. For example, upon receipt of an incoming call, the STB 106 can present a list of options on a display device, such as in a pop-up window or semi-transparent text. The particular method of presentation can vary and can be pre-selected by a user, including by designation in a user profile. The user of the STB 106 can then choose the call management option desired, such as accepting the call, returning the call at a later time, transferring the call to another communication device, sending the call to voice mail and/or not accepting the call. The selection of the particular option can be controlled by a number of devices, such as the STB remote control or another communication device (e.g., mobile phone) that is also in communication with the STB 106.

In step 606, the STB 106 can determine from the call management rules whether the incoming call is to be accepted and if so, in step 608 can establish the communication or otherwise allow for establishing of the communication by another apparatus or system, such as a network proxy. A speaker phone or other component of the STB 106 can be utilized for voice communication between the user of the STB and the caller.

If the STB 106 determines that the call is not to be accepted then in step 610 the STB can determine from the call management rules whether a subsequent communication is to be established with the caller and if so, in step 612 can provide a message to the caller and establish the subsequent communication or otherwise allow for establishing of the subsequent communication by another apparatus or system, such as a network proxy. For example, the STB 106 can present a message to the caller indicating that the callee will return the call at a specified time, such as after the presentation of the media content is finished or in a selected amount of time (e.g., in fifteen minutes). At the specified time, the STB 106 can attempt to establish a communication with the previous caller. In one embodiment, the communication can be made to the same device that the caller utilized to place the original call. In another embodiment, the caller can designate a communication device that is to receive the call from the STB 106 in response to the message from the STB indicating a return call will be provided.

In yet another embodiment, the STB 106 or other apparatus and/or system can utilize presence information associated with the caller to establish the subsequent communication. The presence information can be derived from various sources, such as Global Positioning System (GPS) coordinate information received by a network proxy directly from one or more of the callers communication devices. The presence information can also include device activity information which can be used to hone in on which device is most likely used by the caller at the designated time for the return communication. The presence information can be derived by numerous techniques, and can vary depending upon the particular type of communication device. For example, monitoring of various communication devices associated with the user, such as a cellular phone in transit which is being detected by a series of base stations or a computer that is exhibiting network activity, can be performed. Such activities, as well as others, can be indicative of use by the caller or a likelihood of success in contacting the caller. In one embodiment, the presence information can be retrieved or otherwise determined by a presence server or system in communication with the STB 106.

If the STB 106 determines that a return call is not to be set up then in step 614 the STB can determine from the call management rules whether the call is to be transferred and if so, in step 616 can transfer the call to another communication device. In one embodiment, the STB 106 can transfer the call to another communication device associated with the user of the STB 106, which can be determined based on the user profile. In another embodiment, the user of the STB 106 can designate a communication device that is to receive the transferred call, such as by selecting from a list of devices or entering a communication device identifier (e.g., through entering data using the STB remote controller). In yet another embodiment, the STB 106 can establish multiple-way calling between the caller, the STB 106 and one or more other communication devices, such as according to a selection by the user of the STB.

If the STB 106 determines that the call is not to be transferred to another communication device then in step 618 the STB can determine from the call management rules whether the call is to be placed into voice mail and if so, in step 620 can transfer the call to the desired voice mail. In one embodiment, the STB 106 can transfer the call to the voice mail of a communication device associated with the user of the STB, which can be determined based on the user profile. In another embodiment, the user of the STB 106 can designate the voice mail that is to receive the transferred call, such as by selecting from a list of devices or entering a communication device identifier (e.g., through entering data using the STB remote controller). In yet another embodiment, the STB 106 can transfer the call into a voice mail of the STB, where the user of the STB and/or others can selectively access the voice mail, such as using a password or the like. In step 622, the communication between the caller and the user of the STB 106 can be disconnected.

In one embodiment, the STB 106 can monitor for a request for a call management function during the call. For example, a user of the STB 106 can request implementation of a call management function by the STB, such as by selecting from an option list using the STB remote controller. If such a request is made by the user of the STB 106 during the call then the method 600 can return to steps 606 through 620 for managing the on-going call.

From the foregoing descriptions, it would be evident to an artisan with ordinary skill in the art that the aforementioned embodiments can be modified, reduced, or enhanced without departing from the scope and spirit of the claims described below. For example, the call management rules can be established by a user for an STB or for a user profile associated with an STB using a web page. The web page can be adjusted or otherwise populated with data using a number of devices, including the remote controller of the STB, a mobile phone, a personal computer, and so forth (e.g., over the internet). Other remote communication devices and modes can also be used to establish the call management rules that are to be implemented by the STB. In one embodiment, the call management rules can be based at least in part on the media content being presented. For example, one call management rule can implement a return call only after a VOD movie is over, while another call management rule can implement the call return during a commercial of regularly scheduled programming.

In one embodiment, implementation of the call management rules can be selected using a number of different devices, including the STB remote controller, a mobile phone and/or a personal computer. For example, a user of the STB can communicate a call management selection to the STB using his or her mobile phone, such as in response to a list of call management options presented on the display device. The mobile phone can communicate directly with the STB using various modes of communication. In one embodiment, the STB can include multi-mode communication components to detect the presence and/or communication mode of a mobile phone, and then transmit and/or receive communication signals using that mode of communication (e.g., cordless phone technology (e.g., DECT), Bluetooth™, Wireless Fidelity (WiFi), Worldwide Interoperability for Microwave Access (WiMAX), Ultra Wide Band (UWB), software defined radio (SDR), and/or cellular access technologies such as CDMA-1X, W-CDMA/HSDPA, GSM/GPRS, TDMA/EDGE, and EVDO). In another embodiment, the STB can initiate return calls to multiple parties, which can include the original caller. The return call can be placed using various mode of communication which can include VoIP or which can be another mode, including IMS, POTS, and so forth. The present disclosure also contemplates the use of presence information, such as maintained by a presence server and communicated to the STB, for initiating return calls to other parties (e.g., three-way calling) and/or for forwarding the incoming call to another communication device.

These are but a few examples of the modifications that can be applied to the present disclosure without departing from the scope of the claims. Accordingly, the reader is directed to the claims for a fuller understanding of the breadth and scope of the present disclosure.

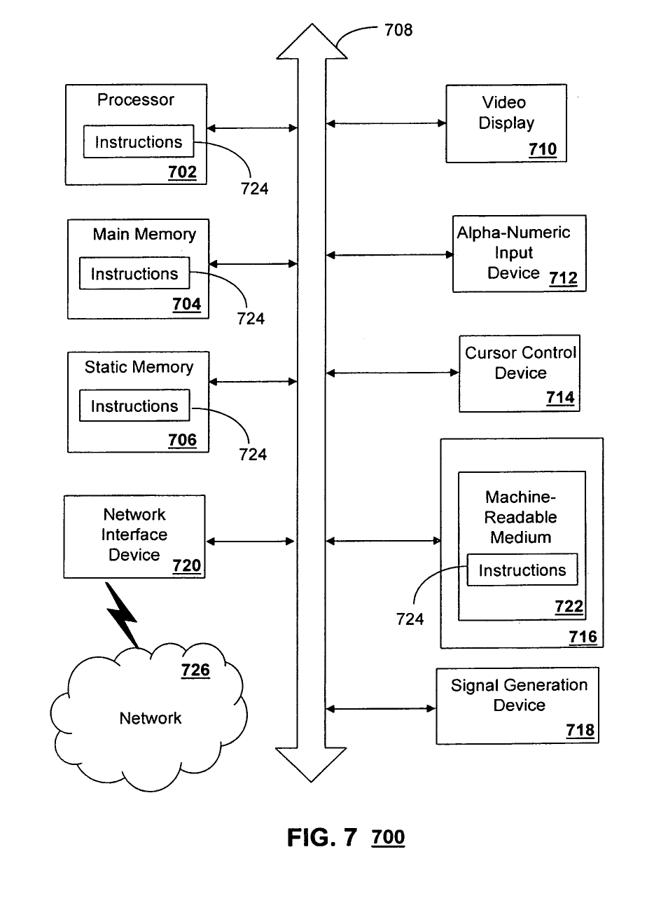

FIG. 7 depicts an exemplary diagrammatic representation of a machine in the form of a computer system 700 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 700 may include a processor 702 (e.g., a central processing unit (CPU), a graphics processing unit (GPU, or both), a main memory 704 and a static memory 706, which communicate with each other via a bus 708. The computer system 700 may further include a video display unit 710 (e.g., a liquid crystal display (LCD), a flat panel, a solid state display, or a cathode ray tube (CRT)). The computer system 700 may include an input device 712 (e.g., a keyboard), a cursor control device 714 (e.g., a mouse), a disk drive unit 716, a signal generation device 718 (e.g., a speaker or remote control) and a network interface device 720.

The disk drive unit 716 may include a machine-readable medium 722 on which is stored one or more sets of instructions (e.g., software 724) embodying any one or more of the methodologies or functions described herein, including those methods illustrated above. The instructions 724 may also reside, completely or at least partially, within the main memory 704, the static memory 706, and/or within the processor 702 during execution thereof by the computer system 700. The main memory 704 and the processor 702 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 724, or that which receives and executes instructions 724 from a propagated signal so that a device connected to a network environment 726 can send or receive voice, video or data, and to communicate over the network 726 using the instructions 724. The instructions 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium, comprising computer instructions for:
receiving a call at a set top box from a communication device;
presenting notice of receipt of the call on a display device coupled to the set top box;
providing a message to the communication device that a user of the set top box will provide a return call at a specified time; and
initiating the return call from the set top box to the communication device at the specified time.

2. The storage medium of claim 1, comprising computer instructions for determining the specified time based on data provided to the set top box by a remote controller of the set top box.

3. The storage medium of claim 2, wherein the user of the set top box provides the data based on a selection presented on the display device.

4. The storage medium of claim 1, wherein the call is directed to a premises associated with the user of the set top box and is received by the set top box from a premises communication device.

5. The storage medium of claim 1, comprising computer instructions for accessing a profile associated with the user of the set top box, wherein the message is based at least in part on information in the profile.

6. The storage medium of claim 5, comprising computer instructions for determining the specified time to initiate the return call based on the information in the profile.

7. The storage medium of claim 1, comprising computer instructions for initiating the return call from the set top box to a plurality of communication devices.

8. The storage medium of claim 7, wherein initiation of the return call to at least one communication device of the plurality of communication devices is based on presence information associated with a user of the at least one communication device.

9. The storage medium of claim 1, comprising computer instructions for the set top box to present media content on the display device based on received internet protocol signals.

10. The storage medium of claim 1, comprising computer instructions for the set top box to initiate the return call using a mode of communication other than voice over internet protocol.

11. The storage medium of claim 1, wherein the specified time is based at least in part on media content being presented when the call is received.

12. A set top box comprising a controller to:
receive a call from a communication device, the set top box being in communication with an internet protocol television system for presenting media content on a display device;
present notice of receipt of the call on the display device;
retrieve a call management function from a profile associated with a user of the set top box;
apply the call management function to the call; and
initiate a return call from the set top box at a pre-determined time.

13. The set top box of claim 12, wherein the call management function is one among accepting the call, forwarding the call to another communication device, and forwarding the call to a voice mail.

14. The set top box of claim 12, wherein the call management function comprises:
providing a message to the communication device that the user of the set top box will provide the return call to a caller.

15. The set top box of claim 14, wherein the controller is adapted to initiate the return call to another communication device associated with the caller.

16. The set top box of claim 15, wherein the controller is adapted to utilize presence information associated with the caller to determine the another communication device.

17. The set top box of claim 12, wherein the call management function comprises forwarding the call to another communication device associated with the user of the set top box, wherein presence information is utilized to determine the another communication device.

18. The set top box of claim 12, wherein the call management function comprises initiating the return call to the communication device and to another communication device.

19. The set top box of claim 12, wherein the controller is adapted to apply another call management function during the call.

20. A set top box comprising a controller to:
receive a call from a communication device;
present notice of receipt of the call on a display device coupled to the set top box;
provide a message to the communication device that a user of the set top box will provide a return call at a pre-determined time; and
initiate the return call from the set top box at the pre-determined time.

21. The set top box of claim 20, wherein the controller is adapted to initiate the return call to another communication device associated with a caller.

22. The set top box of claim 21, wherein the controller is adapted to utilize presence information associated with the caller to determine the another communication device.

23. A set top box comprising a controller to:
receive a call from a communication device, the set top box being in communication with an internet protocol television system;
present notice of receipt of the call on a display device coupled to the set top box;
present a list of call management functions on the display device, the call management functions comprising initiating a return call at a predetermined time;
receive a selection of a call management function from a user of the set top box; and
apply the selected call management function to the call.

24. A method, comprising:
receiving a call at a set top box from a communication device, the set top box being in communication with an internet protocol television system;
presenting notice of receipt of the call on a display device coupled to the set top box;
retrieving a call management function from a web page associated with the set top box, wherein the call management function is adjustable by a plurality of devices in communication with the web page over the internet, the plurality of devices comprising a remote controller of the set top box and a mobile phone; and
applying the call management function to the call.

25. The method of claim 24, wherein the call management function comprises:
providing a message to the communication device that a user of the set top box will provide a return call to a caller; and
initiating the return call from the set top box at a pre-determined time.
